(19) United States
(12) Patent Application Publication
(10) Pub. No.: US 2026/0097926 A1
(43) Pub. Date: Apr. 9, 2026

(54) SOLUTION FOR PROVIDING MULTISENSORY OUTPUT DATA FOR AN ELEVATOR USER

(71) Applicant: KONE CORPORATION, Helsinki (FI)

(72) Inventor: Jaana HYVÄRINEN, Helsinki (FI)

(73) Assignee: KONE CORPORATION, Helsinki (FI)

(21) Appl. No.: 19/416,237

(22) Filed: Dec. 11, 2025

Related U.S. Application Data
(63) Continuation of application No. PCT/FI2023/050380, filed on Jun. 22, 2023.

(51) Int. Cl. B66B 3/00; B66B 1/46; B66B 1/50; B66B 11/02

(52) U.S. Cl. CPC B66B 3/008; B66B 1/468; B66B 11/0233; B66B 1/50; B66B 2201/463; B66B 2201/4646; B66B 2201/4653

(57) ABSTRACT

A method provides multisensory output data for an elevator user. The method includes: receiving input data representing a user related prompt from an input device system, the input data being generated by the input device system in response to an interaction with the elevator user; generating the multisensory output data based on the received in-put data by applying a generative artificial intelligence (AI) model, the generated multisensory output data reflecting the user related prompt; and providing the generated multisensory output data to an elevator car output device system for outputting the generated multisensory output data for the elevator user during an elevator journey. A multisensory output data generation system, a computer program product, and a tangible non-volatile computer-readable medium are also provided.

### TECHNICAL FIELD

The invention concerns in general the technical field of elevators. Especially the invention concerns providing multisensory output data for an elevator user.

### BACKGROUND

Generative artificial intelligence (AI) refers to a category of artificial intelligence algorithms and models designed to generate new content, data, or patterns based on the information they have been trained on. These models learn to understand and mimic the structure, characteristics, and relationships within the training data and may create diverse outputs, such as text, images, audio, or even complex systems. The generative AI has numerous applications, including content creation, image synthesis, data augmentation, language translation, and creative problem-solving, among others.

An example of the generative AI is Generative Adversarial Network (GAN), which consists of two neural networks: a generator and a discriminator, working together in a process where the generator creates new content, and the discriminator evaluates its quality. Another example of the generative AI is Generative Pre-trained Transformer (GPT) series, which includes models, such as GPT-4, designed for natural language processing tasks and capable of generating human-like text based on input prompts.

Typically, the technology behind generative AI for image creation involves advanced deep learning models, e.g. convolutional neural networks (CNNs), GANs, Variational Autoencoders (VAEs) and PixelCNNs, that learn the intricate patterns and structures in visual data, enabling them to create diverse and realistic images. The generative AI model uses its knowledge of the relationships between textual prompts and visual features to create an image that best represents the given prompt. The quality and accuracy of the generated image may depend on the clarity of the prompt and the model's ability to understand and translate the prompt into a visual representation.

Elevator systems typically comprises output interface devices that may be used to output sensory data, e.g. visuals or soundscapes, for users of the elevator system. Typically, the sensory data is predefined, e.g. by the elevator company, the owner of the building, and/or the operator of the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a multisensory output data generation system, a computer program product, and a tangible non-volatile computer-readable medium for providing multisensory output data for an elevator user. Another objective of the invention is that the method, a multisensory output data generation system, a computer program product, and a tangible non-volatile computer-readable medium for providing multisensory output data for an elevator user enable providing a personalized user specific user experience for the elevator user.

The objectives of the invention are reached by a method, a multisensory output data generation system, a computer program product, and a tangible non-volatile computer-readable medium as defined by the respective independent claims.

According to a first aspect, a method for providing multisensory output data for an elevator user is provided, wherein the method comprises: receiving input data representing a user related prompt from an input device system, wherein the input data is generated by the input device system in response to an interaction with the elevator user; generating the multisensory output data based on the received input data by applying a generative artificial intelligence (AI) model, wherein the generated multisensory output data reflects the user related prompt; and providing the generated multisensory output data to an elevator car output device system for outputting the generated multisensory output data for the elevator user during an elevator journey.

The input data may comprise a textual prompt, a voice prompt, a gesture prompt, and/or sensor data.

The method may further comprise using further input data in the generation of the multisensory output data in addition to the received input data, wherein the further input data may comprise statistical data, prestored data relating to the elevator user, historical data, and/or elevator journey data.

The multisensory output data may comprise visual output data, audio output data, haptic output data, and/or scent output data.

The input device system may comprise an elevator call giving device arrangement, a mobile terminal device of the elevator user, and/or a sensor device arrangement.

The elevator car output device system may comprise an elevator car display system, an elevator car speaker system, an elevator car lighting system, an elevator car scent emission system, and/or an elevator car haptic output system.

The interaction with the elevator user may comprise an active interaction comprising an active input action by the elevator user and/or a passive interaction, in which the input data is gathered without an active input action by the elevator user.

The receiving of the input data may be an iterative process applying the generative AI model, wherein the iterative process may comprise multiple request-user related prompt cycles.

The user related prompt may be an indirect prompt of the multisensory output data to be generated.

Alternatively or in addition, the method may further comprise: providing the generated multisensory output data to a building output interface device system for outputting at least part of the generated user multisensory output data for the elevator user, providing the generated multisensory output data to a mobile terminal device of the elevator user for outputting at least part of the generated output data for the elevator user via the mobile terminal device, and/or providing the generated multisensory output data for utilizing the generated multisensory output data in an augmented environment and/or in a virtual environment.

According to a second aspect, a multisensory output data generation system for providing multisensory output data for an elevator user is provided, wherein the system comprises: an input device system for providing input data, an elevator car output device system for outputting the multisensory output data, and a computing unit communicatively coupled to the input device system and to the elevator car output device system and configured to: receive input data representing a user related prompt from the input device system, wherein the input data is generated by the input device system in response to an interaction with the elevator user; generate the multisensory output data based on the received input data by applying a generative artificial intelligence (AI) model, wherein the generated multisensory output data reflects the user related prompt; and provide the generated multisensory output data to the elevator car output device system for outputting the generated multisensory output data for the elevator user during an elevator journey.

The input data may comprise a textual prompt, a voice prompt, and/or a gesture prompt.

The computing unit may further be configured to use further input data in the generation of the multisensory output data in addition to the received input data, wherein the further input data may comprise statistical data, prestored data relating to the elevator user, historical data, and/or elevator journey data.

The multisensory output data may comprise visual output data, audio output data, haptic output data, and/or scent output data.

The input device system may comprise an elevator call giving device arrangement, a mobile terminal device of the elevator user, and/or a sensor device arrangement.

The elevator car output device system may comprise an elevator car display system, an elevator car speaker system, an elevator car lighting system, an elevator car scent emission system, and/or an elevator car haptic output system.

The interaction with the elevator user may comprise an active interaction comprising an active input action by the elevator user and/or a passive interaction, in which the input data is gathered without an active input action by the elevator user.

The receiving of the input data may be an iterative process applying the generative AI model, wherein the iterative process may comprise multiple request-user related prompt cycles.

The user related prompt may be an indirect prompt of the multisensory output data to be generated.

Alternatively or in addition, the computing unit may further be configured to: provide the generated multisensory output data to at a building output interface device system for outputting at least part of the generated multisensory output data for the elevator user, provide the generated multisensory output data to a mobile terminal device of the elevator user for outputting at least part of the generated output data for the elevator user via the mobile terminal device, and/or providing the generated multisensory output data for utilizing the generated multisensory output data in an augmented environment and/or in a virtual environment.

According to a third aspect, a computer program product is provided, wherein the computer program product comprises instructions which, when the program is executed by a computer, cause the computer to carry out the method described above.

According to a fourth aspect, a tangible non-volatile computer-readable medium is provided, wherein the tangible non-volatile computer-readable medium comprises instructions which, when executed by a computer, cause the computer to carry out the method described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of a multisensory output data generation system.

FIG. 3 illustrates schematically an example of a method for providing multisensory output data for an elevator user.

FIG. 4 illustrates schematically an example of an iterative process for receiving input data.

FIG. 5 illustrates schematically an example of components of a computing unit.

### DESCRIPTION OF THE EXEMPLIFYING EMBODIMENTS

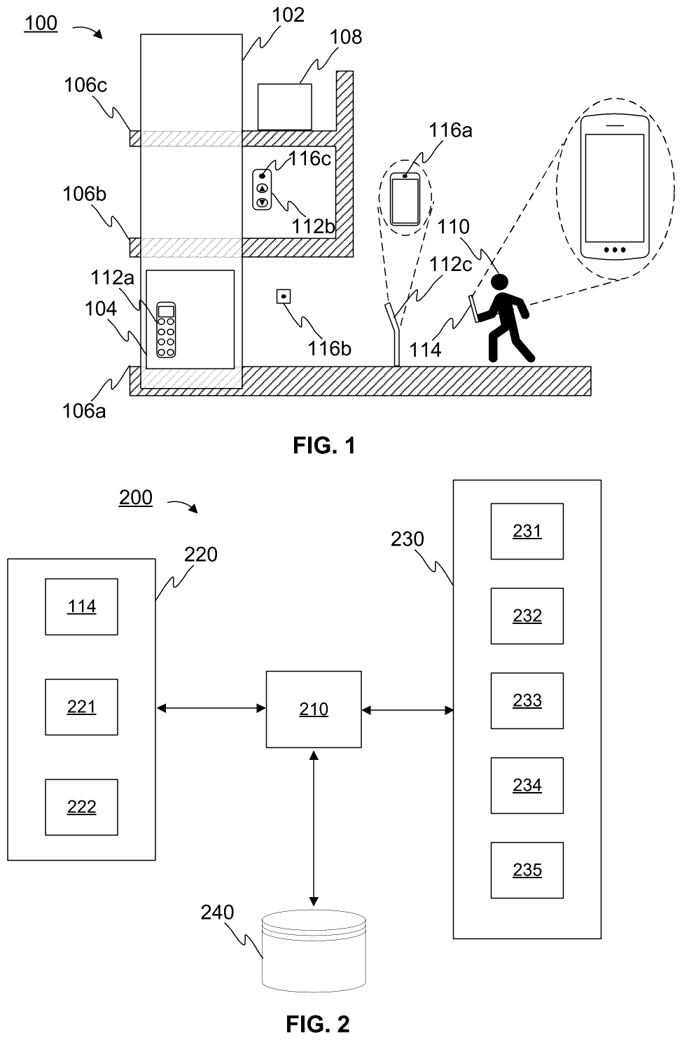

FIG. 1 illustrates schematically an example of an elevator system 100. The elevator system 100 comprises an elevator shaft 102 along which an elevator car 104 is configured to drive between a plurality of floors, i.e. landings, 106a-106c, an elevator control system 108, and a multisensory output data generation system 200 for providing a multisensory output data for an elevator user 110. The elevator system 100 may also form an elevator group, i.e. group of two or more elevator cars 104 each travelling along a separate elevator shaft 102 configured to operate as a unit serving the same landings 106a-106n. For sake of clarity only three floors 106a-106c are shown in FIG. 1, but the number of floors 106a-106c is not limited. The elevator system 100 further comprises a hoisting system configured to drive the at least one elevator car 104 along the at least one elevator shaft 102 between the floors 106a-106c. For sake of clarity the hoisting system is not shown in FIG. 1.

The elevator control system 108 may be configured to at least control the operations of the elevator system 100. In the example of FIG. 1 the elevator control system 108 locates in one of the floors 106c, but the elevator control system 108 may also locate inside a machine room (for clarity reasons the machine room is not shown in FIG. 1). The elevator control system 108 is communicatively coupled to the other entities of the elevator system 100. The communication between the elevator control system 108 and the other entities of the elevator system 100 may be based on one or more known communication technologies, either wired or wireless. The implementation of the elevator control system 108 may be done as a stand-alone control entity or as a distributed control environment between a plurality of stand-alone control entities, such as a plurality of servers providing distributed control resource.

The elevator system 100 further comprises an elevator car call device 112a arranged inside the elevator car 104. If the elevator system 100 forms the elevator group, an elevator call device 112a is arranged inside each elevator car 104. The elevator car call device 112a may for example be a car operating panel (COP). The elevator car call device 112a may comprise a user interface for generating car calls to control at least one operation of the elevator system 100, e.g. to drive the elevator car 104 to a desired destination floor, open or close elevator doors (landing door(s) and/or elevator car door(s)), generating an elevator alarm, making an emergency call, etc. The car call may comprise an information of the destination floor to which the at least one elevator car 104 is desired to travel. Furthermore, the elevator system 100 may comprise at least one landing call device 112b arranged to each floor 106a-106c. The at least one landing call device 112b may for example be a landing call station (LCS). The landing call device 112b may comprise a user interface for generating landing calls to control at least one operation of the elevator system 100, e.g. to drive the at least one elevator car 104 to a desired departure floor 106a-106c, i.e. said floor 106a-106c where said landing call device 112b resides. The landing call may comprise information of the direction of travel, i.e. upwards or downwards, to which the at least one elevator car 104 is desired to travel. Alternatively or in addition, the elevator system 100 may comprise at least one destination call device 112c arranged to at least one floor 106a-106c. The at least one destination call device 112c may for example be a destination operation panel (DOP). The destination call device 112c may comprise a user interface e.g. for generating destination calls to control at least one operation of the elevator system 100, e.g. to drive the at least one elevator car 104 first to a desired departure floor 106a-106c, i.e. said floor 106a-106c where said landing call device 112b resides, and then to a desired destination floor. The destination call may comprise at least information of the desired destination floor to which the at least one elevator car 104 is desired to travel. In the example of FIG. 1 the destination call device 112c is arranged to a separate support element, e.g. a stand, but the destination call device 112c may also be arranged e.g. to a wall at the floor 106a-106c, e.g. within a landing area or an elevator lobby area. The elevator car call device(s) 112a, the elevator landing call device(s) 112b, and the destination call device(s) 112c belong to an elevator call giving device arrangement 221.

The elevator system 100 may further comprise one or more sensor devices 116a-116c. In the example of FIG. 1 the elevator system 100 comprises three sensor devices, but the number of the sensor devices 116a-116c is not limited. The one or more sensor devices 116a-116c of the elevator system 100 may for example comprise one or more imaging sensor devices configured to provide image data, one or more motion sensor devices configured to provide motion data, one or more user identification devices configured to provide user identification data, and/or any other sensor devices. The one or more imaging sensor devices may for example comprise, but are not limited to, one or more optical imaging devices configured to provide optical image data. The optical image data may comprise one or more images and/or video image comprising a plurality of consecutive images, i.e. frames. The one or more sensor devices 116a-116c may be implemented as a separate entity and/or associated with at least one elevator call giving device 112a-112c of the elevator system 100. The separate entity may be arranged to at least one floor 106a-106c, e.g. to a wall at the at least one floor 106a-106c within at least one landing area or elevator lobby area or next to a landing door of at least one elevator car 104; and/or inside the at least one elevator car 104, e.g. to a wall of the at least one elevator car 104. In the example of FIG. 1 the sensor device 116a is associated with the destination call device 112c, the sensor device 116c is associated with the landing call device 112b, and the sensor device 116b is implemented as a separate entity. With the expression “associated with” it may be meant that the sensor device 116a-116c may be arranged to the elevator call giving device 112a-112c, e.g. integrated to the elevator call giving device 112a-112c as the sensor devices 116a and 116c in the example of FIG. 1. In other words, the sensor device 116a-116c may be an internal entity of the elevator call giving device 112a-112c. Alternatively or in addition, with the expression “associated with” it may be meant that the sensor device 116a-116c may be arranged in a vicinity of, i.e. close to, the elevator call giving device 112a-112c, e.g. to a wall or any another surface next to, above, or below the elevator call giving device 112a-112c, or to a support element, e.g. a stand. The support element may be the same support element to which the elevator call giving device 112a-112c may be arranged or a separate support element. In other words, the sensor device 116a-116c may be an external entity of the elevator call giving device 112a-112c.

The elevator system 100 may further comprise one or more known elevator related entities, e.g. elevator doors, and/or safety circuit and devices, etc., which are not shown in FIG. 1 for sake of clarity.

FIG. 2 illustrates schematically an example of the multisensory output data generation system 200. The multisensory output data generation system 200 comprises a computing unit 210, an input device system 220, and an elevator car output device system 230. The multisensory output data generation system 200 may further comprise or be associated with one or more databases 240. The input device system 220 comprises at least one input device. Each input device of the input device system 220 comprises input means for obtaining the input data. Depending on the type of input data, each input device of the input device system 220 may for example comprise one or more audio input devices, one or more text input devices, one or more gesture input devices, and/or one or more sensors, etc. Each input device of the input device system 220 may further comprise output means for providing output, if necessary. For example, each input device of the input device system 220 may comprise one or more visual output devices, one or more textual output devices, and/or one or more audio output devices, etc. The input device system 220 may comprise at least one of the following input devices: a mobile terminal device 114 of the elevator user 110, the elevator call giving device arrangement 221, and/or the sensor device arrangement 222. The elevator call giving device arrangement 221 may for example comprise at least one destination call device (e.g. at least one DOP) 112c of the elevator system 100, a car call device (e.g. a COP) 112b of the elevator system 100, or at least one landing call device (e.g. at least one LCS) 112a of the elevator system 100. The sensor device arrangement 222 may comprise the one or more sensor devices 116a-116c of the elevator system 100 and/or one or more other sensor devices being external to the elevator system 100. The one or more other sensor devices may for example comprise one or more sensor devices carried by the elevator user 110 (e.g. a wearable sensor device, such as a smartwatch, or smart jewellery (e.g. a smart ring), etc.) and/or one or more sensor devices residing inside a building, in which the elevator system 100 resides. The elevator car output device system 230 may for example comprise an elevator car display system 231, an elevator car speaker system 232, an elevator car lighting system 233, an elevator car scent emission system 234, and/or an elevator car haptic output system 235. If the elevator system 100 forms an elevator group, each elevator car 104 comprises an elevator car output device system 230. The elevator car display system 231 may comprise one or more display devices arranged inside the elevator car 104. The one or more display devices of the elevator car display system 231 may comprise a display of the elevator car call device 112a and/or any other display devices arranged inside the elevator car 104 and configured to provide visual output. The elevator car speaker system 232 may comprise one or more speaker devices configured to provide audio output inside the elevator car 104. The elevator car lighting system 233 may comprise one or more lighting devices configured to illuminate the interior of the elevator car 104. The elevator car scent emission system 234 may comprise one or more scent devices configured to emit scent inside the elevator car 104. The elevator car haptic output system 235 may comprise one or more haptic devices arranged to the elevator car 104, e.g. to the floor of the elevator car 104, to the wall(s) of the elevator car 104, and/or to the elevator car call device 112a, and configured to provide haptic output. The computing unit 210 may be implemented as an internal entity of the elevator system 100, e.g. as a part of the elevator control system 108. Alternatively, the computing unit 210 may be implemented as an external entity of the elevator system 100. For example, the computing unit 210 implemented as the external entity of the elevator system 100 may be a cloud server, a data center, a building management control system, a local server, a service center, or a maintenance center. In case the computing unit 210 is implemented as the external entity of the elevator system 100, the computing unit 210 may be communicatively coupled to the elevator control system 108. The communication between the computing unit 210 and the elevator control system 108 may be based on one or more known communication technologies, either wired or wireless. The implementation of the computing unit 210 may be done as a stand-alone computing entity or as a distributed control environment between a plurality of stand-alone computing entities, such as a plurality of servers providing distributed computing resource. The computing unit 210 is communicatively coupled to the input device system 220 and to the elevator car output device system 230. The communication between the computing unit 210 and the input device system 220 may be based on one or more known communication technologies, either wired or wireless. The communication between the computing unit 210 and the elevator car output device system 230 may be based on one or more known communication technologies, either wired or wireless. The computing unit 201 may further be communicatively coupled to the one or more databases. The communication between the computing unit 210 and the one or more databases 240 may be based on one or more known communication technologies, either wired or wireless.

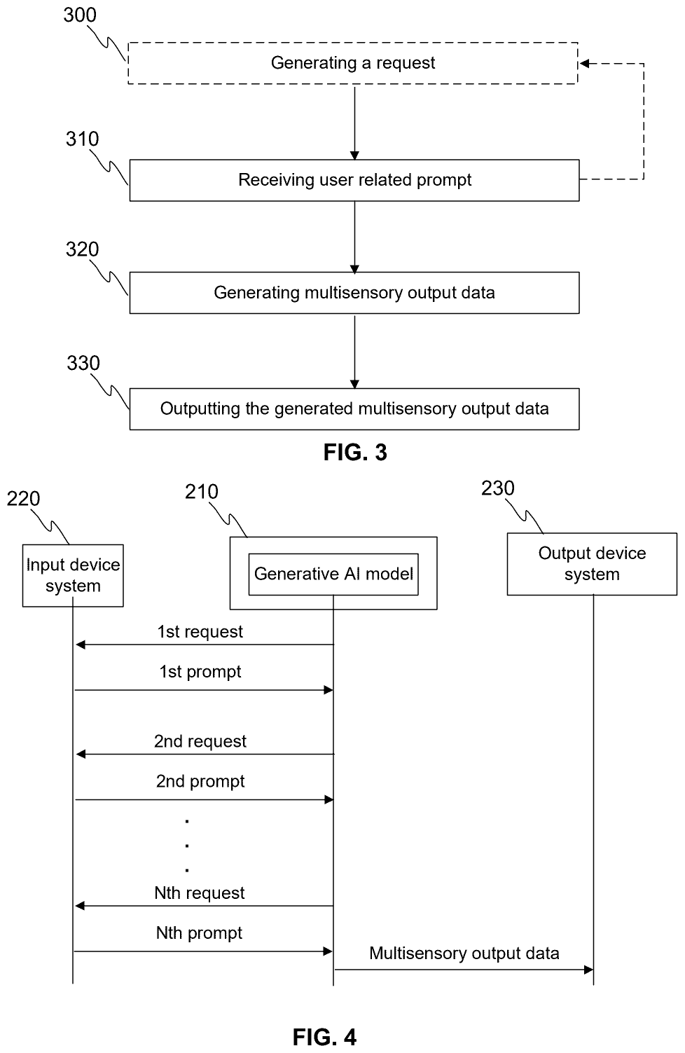

Next an example of a method for providing multisensory output data for the elevator user 110 is described by referring to FIG. 3. FIG. 3 schematically illustrates the method as a flow chart. The method is a computer-implemented method performed by the multisensory output data generation system 200 described above.

At a step 310, the computing unit 210 receives from the input device system 220 input data representing a user related prompt for providing of the multisensory output data for the elevator user 110. The input data may be generated by the input device system 220 in response to an interaction with the elevator user 110. The interaction with the elevator user 110 may occur before an elevator journey of the elevator user 110 and/or during the elevator journey of the elevator user 110. The elevator journey of the elevator user 110 comprises at least the elevator drive (from the departure floor to the destination floor). The elevator journey may further comprise an entry by the elevator user 110 into the elevator car 104 and/or an exit by the elevator user 110 from the elevator car 104. The interaction with the elevator user 110 may comprise an active interaction and/or a passive interaction. In the active interaction, the elevator user 110 inputs the user related prompt via a user interface of an input device of the input device system 220. In other words, the active interaction comprises an active input action by the elevator user 110 via at least one input device of the input device system 220. In the passive interaction, the input data is gathered by at least one input device of the input device system 220 without an active input action by the elevator user 110. In other words, the input data may be inputted by the elevator user 110 via at least one input device of the input device system 220 and/or gathered by at least one input device of the input device system 220. The type (i.e. active or passive) interaction with the elevator user 110 may depend on the input device. For example, in case the input device is the mobile terminal device 114 of the elevator user 110, the interaction with the elevator user 110 may comprise active interaction, i.e. the elevator user 110 may input the user related prompt via the user interface of the mobile terminal device 114 of the elevator user 110. According to another example, in case the input device is an elevator call giving device 112a-112c of the elevator call giving device arrangement 221, the interaction with the elevator user 110 may comprise active interaction, i.e. the elevator user 110 may input the user related prompt via the user interface of the elevator call giving device 112a-112c. According to yet another example, in case the input device is a sensor device 116a-116c of the sensor device arrangement 222, the interaction with the elevator user 110 comprise passive interaction, i.e. the input data is gathered by the input device without active input action by the elevator user 110, or active interaction, i.e. the elevator user 110 may input the user related prompt via the input device.

The user related prompt is received from the input device system 220 for providing the multisensory output data for the elevator user 110. The generation of the multisensory output data based on the received input data representing the user related prompt will be described later in this application. The generated multisensory output data reflects the user related prompt. The user related prompt may represent an indication of a user experience, e.g. a multisensory atmosphere, that the generated multisensory output data is expected or wanted to produce for the elevator user 110 during the elevator journey.

In the active interaction with the elevator user 110, the computing unit 210 may first generate via an input device of the input device system 220 a request for the elevator user 110 to provide the user related prompt via the input device. This is illustrated with an optional step 300 in the example of FIG. 3. The request may for example be, but is not limited to, a text request, a visual request, and/or a voice request. For example, in case the input device is the elevator call giving device 112a-112c, when the elevator user 110 arrives at the elevator call giving device 112a-112c, the computing unit 210 may control the elevator call giving device 112a-112c to generate, e.g. via the user interface of the elevator call giving device 112a-112c, the request for the elevator user 110 to provide the user related prompt for generating the multisensory output data. The request may for example be generated, when the user has made or is making the elevator call (e.g. a car call, a landing call, or a destination call) via the elevator call giving device 112a-112c).

In the active interaction with the elevator user 110, the user related prompt may for example be a textual prompt, a voice prompt, and/or a gesture prompt. In the passive interaction with the elevator user 110, the user related prompt may for example comprise sensor data gathered by the sensor device arrangement 222 of the input device system 220. The sensor data may for example represent real-time data. The sensor data may for example comprise user related sensor data, user identification data, and/or environment sensor data. The user related sensor data may for example comprise essence data of the elevator user 110, body related data of the elevator user 110, and/or any other data of the elevator user 110 that may be gathered by the sensor device arrangement 222 of the input device system 220. The essence data of the elevator user 110 may for example comprise, but is not limited to, motion data of the elevator user 110, gesture data of the elevator user 110, and/or posture data of the elevator user 110. The essence data of the elevator user 110 may for example be gathered by the one or more imaging sensor devices (e.g. cameras or video cameras). The essence data of the elevator user 110 may for example be optical image data. The body related data of the elevator user 110 may for example comprise, but is not limited to, heart rate of the elevator user 110 and/or a body temperature of the elevator user 110. The body related data of the elevator user 110 for example be gathered by using the one or more sensor devices carried by the elevator user, e.g. a wearable sensor device, and/or by using one or more other sensor devices being external to the elevator system 100 and applicable to gather the body related data of the elevator user 100. For example, the body temperature of the elevator user 110 may be gathered by using a thermal imaging sensor device. The user identification data enables identification of the elevator user 110. The user identification may be based on one or more known user identification technologies, e.g. keycards; tags; identification codes, such as personal identity number (PIN) code or ID number; and/or biometric technologies, such as fingerprint, facial recognition, iris recognition, retinal scan, voice recognition, etc. The user identification data may be gathered by using one or more known applicable user identification devices. The environment sensor data may for example comprise, but is not limited to, temperature data, weather data, and/or humidity data. The environment data may be gathered by using one or more applicable sensor devices.

At a step 320, the computing unit 210 generates the multisensory output data based on, i.e. from, the received input data by applying the generative artificial intelligence (AI) model 526. In other words, the computing unit 210 feeds the received input data to the generative AI model 526 to generate the multisensory output data as an output of the generative AI model 526. Generative AI is a type of Artificial Intelligence technology that is able to produce, i.e. generate, various type of output data content including, but is not limited to, images, videos, audio, text, and/or 3D models, etc. The generative AI produces the output data content by learning patterns and structure from existing data then by using this knowledge to generate new and unique outputs. The generative AI is capable of producing highly realistic and complex content that mimics human creativity. The generative AI may be capable of understanding input and generating output in a conversational context, which allows dynamic interactive dialogues with the elevator user 110. The generative AI model 526 may use its knowledge of the relationships between the user related prompt and multisensory output data features to generate the multisensory output data that best represents the received user related prompt. The knowledge of the relationships between the user related prompt and multisensory output data features by the generative AI model 526 is achieved by training the generative AI model 526. The generative AI model 526 may for example be a Generative Adversarial Network (GAN) model, a Generative Pre-trained Transformer (CPT)-based model, or any other generative AI model. The generative AI model 526 may be trained by applying a transfer learning. The training data used in the transfer learning may for example comprise visual data, audio data, haptic data, and/or scent data together with different input prompt data so that the generative AI model 526 achieves a knowledge of the relationships between the user related prompts and the multisensory output data features. The training data may for example be provided by the elevator company, building owner of a building in which the elevator system 100 resides, and/or organization(s) operating the building. Alternatively or in addition, open source data may be utilized in the training of the generative AI model 526. According to an example, further input data may further be used in the generation of the multisensory output data in addition to the received input data. The further input data may for example comprise, but is not limited to, statistical data, historical data, prestored data relating to the elevator user 110, and/or elevator journey data. The historical data may comprise historical data relating to the elevator user 110 and/or historical data relating to similar elevator users and/or situations. The prestored data relating to the elevator user 110 may be any kind of data relating to the elevator user 110 being prestored. The elevator user 110 may need to be identified based on the user identification data to be able to use the prestored data relating to the elevator user 110. The elevator journey data may for example comprise, but is not limited to, a destination floor of the elevator journey. The statistical data, the historical data, and the prestored data may be obtained for example from one or more databases 240. The elevator journey data may be obtained from the elevator control system 108.

The multisensory output data generated by the generative AI model 526 may comprise visual output data, audio output data, haptic output data, and/or a scent output data. The visual output data may for example comprise, but is not limited to, optical image data (e.g. one or more images and/or video image) and/or lighting. The audio output data may for example comprise, but is not limited to, one or more soundscapes. The haptic output data may for example comprise, but is not limited to, vibrations. The scent output data may comprise one or more scents. In case of the visual output data, the generated multisensory output data may comprise the actual visual output, e.g. one or more images and/or video image, that will be outputted, e.g. displayed, for the elevator user via the elevator car display system 231. Alternatively or in addition, in case of the visual output data, the generated multisensory output data may comprise instructions for controlling the elevator car lighting system 233 to implement the lighting according to the generated visual output data. In case of the audio output data, the generated multisensory output data may comprise the actual audio output, e.g. one or more soundscapes, that will be outputted for the elevator user via the elevator car speaker system 232. In case of the scent output data, the generated multisensory output data may comprise instructions for controlling the elevator car scent emission system 234 to implement the scent according to the generated scent output data. In case of the haptic output data, the generated multisensory output data may comprise instructions for controlling the elevator car haptic output system 235 to implement the haptic output according to the generated haptic output data. According to an example, in case the elevator user 110 may be identified e.g. based on the user related prompt comprising user identification data, the generated multisensory output data may be predefined for said identified elevator user 110. According to another example, in case the elevator user 110 may be identified to belong to a predefined elevator user group e.g. based on the user related prompt comprising sensor data, the generated multisensory data may be predefined for said elevator user group. Some non-limiting examples of the predefined elevator user group may comprise a senior citizen group, a children group, a teenage group, or a pregnant group, etc.

The input-output process of the generative AI model-based output data generation is well known, but next a non-limiting simple example of an input-output process of the generative AI model-based multisensory output data generation is described. The input data may be raw data (i.e. the received input data itself) or data derived from the raw data (i.e. data derived from the received input data). For example, if the input data is video image data, the input data fed to the generative AI model 526 may comprise the video image data itself or data derived (e.g. detected) from the video image data. At a pre-processing step of the input-output process, the received input data (either the raw data or data derived from the raw data) is converted into a numerical representation and the numerical representation of the input data is processed through an embedding layer to create a continuous vector representation capturing the semantic information of the input data, i.e. the semantic information of the user related prompt. The conversion of the received input data into the numerical representation may comprise breaking the input data down into smaller units, i.e. tokens, and mapping into the numerical representation. At a a model processing and decoding step of the input-output process, the embedded input data, i.e. the continuous vector representation, is passed through the generative AI model 526, which leverages its training on the training data to understand the relationship between the user related prompt and the multisensory output data. The generative AI model 526 generates a latent vector that represents essential features of the desired multisensory output data in a lower-dimensional space. At a multisensory output data generation step of the input-output process, the latent vector is transformed into the multisensory output data through a series of upsampling operations (e.g., deconvolutional layers). The generated multisensory output data may further be post-processed for example to enhance the quality of the generated multisensory output data, and/or apply additional effects, etc.

The use of the generative AI model 526 for generating the multisensory output data (and especially the intelligence of the generative AI model) enables that the user related prompt does not need to be (but can be) a direct prompt of the multisensory output data to be generated, but instead the user related prompt may be an indirect prompt of the multisensory output data to be generated. For example, the user related prompt may comprise an indication towards an expected user experience that the generated output multisensory output data is expected to produce for the elevator user 110. Non-limiting examples of the direct prompt (e.g. textual or voice prompt) may comprise the following prompts “create multisensory output representing Christmas theme” “create multisensory output representing pride theme”, or “create multisensory output representing a forest theme”, etc. A non-limiting example of the indirect prompt (e.g. textual or voice prompt) inputted by the elevator user 110 may comprise the following prompt “I am feeling exhausted, but I still have to go to a business meeting and thus, I would need a little cheering up”. The multisensory output data generated by the generative AI model 526 may then be formed by the visual output data, audio output data, haptic output data, and/or the scent output data that the generative AI model 526 deduces to cheer up the elevator user 110.

According to an example, the receiving of the input data may be an iterative process applying the generative AI model 526. The iterative process comprises multiple request-user related prompt cycles. One request-user related prompt cycle comprises a request generated by the computing unit 210 by applying the generative AI model 526 and a user related prompt generated by the elevator user 110 via the input device of the input device system 220. As mentioned above, the generative AI model 526 is capable of taking into account the context of the conversation. Thus, when using the generative AI model 526, the elevator user 110 may provide a series of user related prompts as the input data, and the generative AI model 526 may generate requests based on the given context. In other words, the computing unit 210 may generate the subsequent request based on the previous user related prompt(s) by applying the generative AI model 526. The iterative process of receiving the input data is illustrated in the example of FIG. 3 with the dashed line arrow from the step 310 (in which the input data is received) to the step 300 (in which the request is generated). The number of request-user related prompt cycles is not limited. The iterative process may for example be ended when the multisensory output data may be generated without further user related prompt(s), i.e. the multisensory output data may be generated based on the user related prompt(s) received so far. The iterative process enables generation of multisensory output data that reflects more accurately to the user related prompt(s). The iterative process enables an interactive dialogue between the elevator user 110 and the generative AI model 526 via the input device of the input device system 220. FIG. 4 illustrates schematically an example of the iterative process for receiving the input data. The computing unit 210 may first generate a first request for the elevator user 110 to provide a first user related prompt via the input device 220. The elevator user 110 may generate the first user related prompt via the input device of the input device system 220 in response to the request generated by the computing unit 210. In response to receiving the first user related prompt, the computing unit 210 may apply the generative AI model 526 to the received first user related prompt to generate a second request for the elevator user 110 to provide a second user related prompt via the input device of the input device system 220. In response to receiving the second user related prompt, the computing unit 210 may apply the generative AI model 526 to the received second user related prompt to generate a subsequent request for the elevator user 110 to provide a subsequent user related prompt via the input device of the input device system 220 or alternatively if the multisensory output data may be generated without further user related prompt(s), i.e. the multisensory output data may be generated based on the user related prompt(s) received so far (e.g. in this example based on the first user related prompt and the second user related prompt), the computing unit 210 may generate the multisensory output data based on the user related prompts received so far by applying the generative AI model 526 as described above.

At a step 330, the computing unit 210 provides the generated multisensory output data to the elevator car output device system 230 for outputting the generated multisensory output data for the elevator user 110 during the elevator journey. In case the elevator system 100 forms the elevator group, the computing unit 210 obtain e.g. from the elevator control system 108 information which elevator car 104 is allocated to serve the elevator call made by the elevator user 110 and provide the generated multisensory output data to the elevator car output device system 230 of said elevator car 104. The sub systems 231-235 of the elevator car output device system 230 that are used in the outputting of the generated multisensory output data depend on the generated multisensory output data. For example, if the generated multisensory output data comprises visual output data, the elevator car display system 231 and/or the elevator car lighting system 233 may be used. Alternatively or in addition, if the generated multisensory output data comprises audio data, the elevator car speaker system 232 may be used. Alternatively or in addition, if the generated multisensory output data comprises haptic output data, the elevator car haptic output system 235 may be used. Alternatively or in addition, if the generated multisensory output data comprises scent output data, the elevator car scent emission system 234 may be used. According to an example, the generated multisensory output data may be adjusted during the elevator journey, e.g. according to the destination floor.

According to a non-limiting use case example, the elevator user 110, who is intending to go to a specific destination floor by using the elevator car 104, arrives at the DOP 112c of the elevator system 100 and makes a destination call via the DOP 112c to said specific destination floor. After making the destination call, the control unit 210 may generate via the DOP 112c the request for the elevator user 110 to provide via the DOP 112c user related prompt to be used in the generation of the multisensory output data. In response to the request, the elevator user 110 enters a textual prompt “I would like to have a calming elevator environment” via the DOP 112c. The computing unit 210 receives from the DOP 112c input data comprising the textual prompt entered by the elevator user 110 and generates the multisensory output data based on the received input data by applying the generative AI model 526 as described above. The computing unit 210 provides the generated multisensory output data to the elevator car output device system 230 of the elevator car 104 for outputting the generated multisensory output data for the elevator user 110 during the elevator journey. In this example the generated multisensory output data comprises visual output data, audio output data, haptic output data, and scent output data. When the elevator user 110 enters the elevator car 104 a calming video determined by the generative AI model 526 is displayed for the elevator user 110 via the elevator car display system 231, the elevator car lighting system 233 is arranged to provide a calming lighting determined by the generative AI model 526, a calming soundscape determined by the generative AI model 526 is provided, e.g. played, via the elevator car speaker system 232, a calming vibration determined by the generative AI model 526 is provided via the elevator car haptic output system 235, and a calming scent determined by the generative AI model 526 is emitted via the elevator car scent emission system 234 until the elevator car 104 arrives at the destination floor and the elevator user 110 exits the elevator car 104.

According to an example, the computing unit 210 may further provide the generated multisensory output data to a building output interface device system for outputting at least part of the generated multisensory output data for the elevator user 110 when the elevator user 110 walks inside the building. According to another example, the computing unit 210 may alternatively or in addition provide the generated multisensory output data to the mobile terminal device 114 of the elevator user 110 for outputting at least part of the generated output data for the elevator user 110 via the mobile terminal device 114. The part(s) of the generated output data that may be outputted via the mobile terminal device 114 may comprise visual output data, audio output data and/or haptic output data. According to yet another example, the computing unit 210 may alternatively or in addition provide the generated multisensory output data to be utilized in an augmented environment and/or in a virtual environment (e.g. in a digital twin and/or metaverse environments).

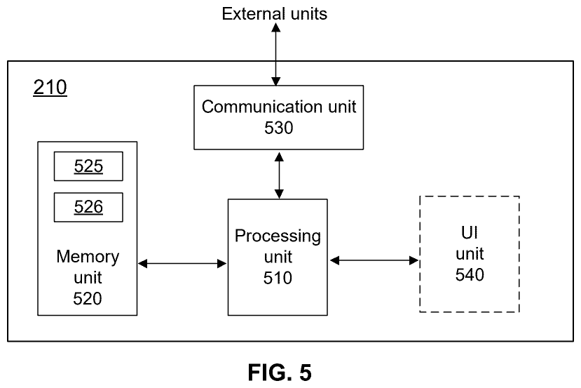

FIG. 5 illustrates schematically an example of components of the computing unit 210. The computing unit 210 may comprise a processing unit 510 comprising one or more processors, a memory unit 520 comprising one or more memories, a communication unit 530 comprising one or more communication devices, and possibly a user interface (UI) unit 540. The mentioned elements may be communicatively coupled to each other with e.g. a communication bus. The memory unit 520 may store and maintain portions of a computer program (code) 525, the generative AI model 526, and data. The computer program 525 may comprise instructions which, when the computer program 525 is executed by the processing unit 510 of the computing unit 210 may cause the processing unit 510, and thus the computing unit 210 to carry out desired tasks, e.g. one or more of the method steps described above. The processing unit 510 may thus be arranged to access the memory unit 520 and retrieve and store any information therefrom and thereto. For sake of clarity, the processor herein refers to any unit suitable for processing information and control the operation of the computing unit 210, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication unit 530 provides one or more communication interfaces for communication with any other unit, e.g. elevator control system 108, the input device system 220, the elevator car output device system 230, one or more databases 240, and/or with any other unit. The user interface unit 540 may comprise one or more input/output (I/O) devices, such as buttons, keyboard, touch screen, microphone, loudspeaker, display and so on, for receiving user input and outputting information. The computer program 525 may be a computer program product that may be comprised in a tangible nonvolatile (non-transitory) computer-readable medium bearing the computer program code 525 embodied therein for use with a computer, i.e. the computing unit 210.

The specific examples provided in the description given above should not be construed as limiting the applicability and/or the interpretation of the appended claims. Lists and groups of examples provided in the description given above are not exhaustive unless otherwise explicitly stated.

1. A method for providing multisensory output data for an elevator user, the method comprises:
receiving input data representing a user related prompt from an input device system, wherein the input data is generated by the input device system in response to an interaction with the elevator user;
generating the multisensory output data based on the received input data by applying a generative artificial intelligence model, wherein the generated multisensory output data reflects the user related prompt; and
providing the generated multisensory output data to an elevator car output device system for outputting the generated multisensory output data for the elevator user during an elevator journey.

2. The method according to claim 1, wherein the input data comprises a textual prompt, a voice prompt, a gesture prompt, and/or sensor data.

3. The method according to claim 1, further comprising using further input data in the generation of the multisensory output data in addition to the received input data, wherein the further input data comprises statistical data, prestored data relating to the elevator user, historical data, and/or elevator journey data.

4. The method according to claim 1, wherein the multisensory output data comprises visual output data, audio output data, haptic output data, and/or scent output data.

5. The method according to claim 1, wherein the input device system comprises an elevator call giving device arrangement, a mobile terminal device of the elevator user, and/or a sensor device arrangement.

6. The method according to claim 1, wherein the elevator car output device system comprises an elevator car display system, an elevator car speaker system, an elevator car lighting system, an elevator car scent emission system, and/or an elevator car haptic output system.

7. The method according to claim 1, wherein the interaction with the elevator user comprises an active interaction comprising an active input action by the elevator user and/or a passive interaction, in which the input data is gathered without an active input action by the elevator user.

8. The method according to claim 1, wherein the receiving of the input data is an iterative process applying the generative AI model, wherein the iterative process comprises multiple request-user related prompt cycles.

9. The method according to claim 1, wherein the user related prompt is an indirect prompt of the multisensory output data to be generated.

10. The method according to claim 1, further comprising:
providing the generated multisensory output data to a building output interface device system for outputting at least part of the generated user multisensory output data for the elevator user,
providing the generated multisensory output data to a mobile terminal device of the elevator user for outputting at least part of the generated output data for the elevator user via the mobile terminal device, and/or
providing the generated multisensory output data for utilizing the generated multisensory output data in an augmented environment and/or in a virtual environment.

11. A multisensory output data generation system for providing multisensory output data for an elevator user, the system comprising:
an input device system for providing input data, an elevator car output device system for outputting the multisensory output data, and a computing unit communicatively coupled to the input device system and to the elevator car output device system and configured to:
receive input data representing a user related prompt from the input device system, wherein the input data is generated by the input device system in response to an interaction with the elevator user;
generate the multisensory output data based on the received input data by applying a generative artificial intelligence model, wherein the generated multisensory output data reflects the user related prompt; and
provide the generated multisensory output data to the elevator car output device system for outputting the generated multisensory output data for the elevator user during an elevator journey.

12. The multisensory output data generation system according to claim 11, wherein the input data comprises a textual prompt, a voice prompt, and/or a gesture prompt.

13. The multisensory output data generation system according to claim 11, wherein the computing unit is further configured to use further input data in the generation of the multisensory output data in addition to the received input data, wherein the further input data comprises statistical data, prestored data relating to the elevator user, historical data, and/or elevator journey data.

14. The multisensory output data generation system according to claim 11, wherein the multisensory output data comprises visual output data, audio output data, haptic output data, and/or scent output data.

15. The multisensory output data generation system according to claim 11, wherein the input device system comprises an elevator call giving device arrangement, a mobile terminal device of the elevator user, and/or a sensor device arrangement.

16. The multisensory output data generation system according to claim 11, wherein the elevator car output device system comprises an elevator car display system, an elevator car speaker system, an elevator car lighting system, an elevator car scent emission system, and/or an elevator car haptic output system.

17. The multisensory output data generation system according to claim 11, wherein the interaction with the elevator user comprises an active interaction comprising an active input action by the elevator user and/or a passive interaction, in which the input data is gathered without an active input action by the elevator user.

18. The multisensory output data generation system according to claim 11, wherein the receiving of the input data is an iterative process applying the generative AI model, wherein the iterative process comprises multiple request-user related prompt cycles.

19. The multisensory output data generation system according to claim 11, wherein the user related prompt is an indirect prompt of the multisensory output data to be generated.

20. The multisensory output data generation system according to claim 11, wherein the computing unit is further configured to:
provide the generated multisensory output data to at a building output interface device system for outputting at least part of the generated multisensory output data for the elevator user,
provide the generated multisensory output data to a mobile terminal device of the elevator user for outputting at least part of the generated output data for the elevator user via the mobile terminal device, and/or
providing the generated multisensory output data for utilizing the generated multisensory output data in an augmented environment and/or in a virtual environment.

21. A non-transitory computer-readable medium storing a computer program product comprising instructions which, when the program is executed by a computer, cause the computer to carry out the method according to claim 1.

22. A tangible non-volatile computer-readable medium comprising instructions which, when executed by a computer, cause the computer to carry out the method according to claim 2.
